(19) United States
(12) Patent Application Publication
(10) Pub. No.: US 2026/0200623 A1
(43) Pub. Date: Jul. 16, 2026

(54) Apparatus for Conveying and Joining Label Tapes

(71) Applicant: Krones AG, Neutraubling (DE)

(72) Inventor: Thorsten GUT, Neutraubling (DE)

(21) Appl. No.: 19/425,264

(22) Filed: Dec. 18, 2025

(30) Foreign Application Priority Data
Jan. 14, 2025 (DE) 102025101071.4

(51) Int. Cl. B65C 9/18; B65C 9/42

(52) U.S. Cl. CPC B65C 9/1892; B65C 9/42

(57) ABSTRACT

An apparatus for conveying and joining label tapes includes a feed device for a first label tape, a withdrawal device for a second label tape, a joining device for joining a first label end of the first label tape to a second label end of the second label tape, and a detection device for detecting a relative arrangement between the first label end and the second label end. The apparatus is configured to use the detected relative arrangement to control the joining device for joining said labels and/or to send a message to an operator that is based on the relative arrangement.

### CROSS-REFERENCE TO RELATED APPLICATIONS

This application claims priority to, and the benefit of, German Patent Application No. 102025101071.4, filed January 14, 2025. The contents of that application are incorporated by reference herein in their entirety.

### TECHNICAL FIELD

The present invention relates to an apparatus for conveying and joining label tapes and to a method for conveying and joining labels.

### PRIOR ART

Apparatuses for conveying and joining label tapes are generally known from the prior art.

For example, CN 115123641 B discloses an apparatus which can be used to automatically change or join label tapes from different rolls of label tape in order to provide a continuous flow of label tape as a label feed for a labeling machine. This involves providing a joining device that can be moved between different devices for providing label tape from label rolls in order to join the ends of the label tapes together. This is done automatically and so only limited or even no manual intervention is required.

However, achieving an exact join between the ends of the label tapes has proven difficult. This can lead to misalignments between a first label tape and a second label tape, resulting in an unsatisfactory conveying result and a worse labeling result after changing the label tape rolls.

### BRIEF SUMMARY

One aspect of the invention relates to an apparatus for conveying and joining label tapes and a method for conveying and joining label tapes, with which the quality of a possible labeling result, or at least the quality of the conveying of the label tapes, is consistently high, regardless of whether the label tape is replaced.

According to the invention, an apparatus for conveying and joining label tapes is provided, the apparatus comprising a feed device for a first label tape, a withdrawal device for a second label tape, a joining device for joining a first label end of the first label tape to a second label end of the second label tape, and a detection device for detecting a relative arrangement between the first label end and the second label end, wherein the device is configured to control the joining device for joining said labels on the basis of the detected relative arrangement and/or to output a message that is based on the relative arrangement to an operator.

The label tapes can be provided in the feed device in the form of a label roll, for example, which is then unwound in the direction of the withdrawal device, but other ways of providing the label tapes (especially the first and second label tape) in the feed device are also conceivable in principle.

The withdrawal device can comprise one or more movable and, in particular driven, rollers that convey the second label tape in a transport direction. A labeling machine or a labeling unit, which is known per se from the prior art, can be arranged downstream of the withdrawal device, for example, and can transfer the labels contained in the label tape to containers such as bottles, cans or the like.

The label tapes are not limited according to the invention. Any label tape can be a label carrier tape with labels detachably arranged thereon. The detachable labels can be attached to the label carrier tape by means of an adhesive and transferred to containers by the side thereof that is arranged on the label carrier tape, for example by folding the label carrier tape at a dispensing edge and thus releasing the label from the label carrier tape. Alternatively, it can also be provided that the labels are not yet provided with adhesive, but are still detachable from the label carrier tape. The labels detached from the label carrier tape can then be provided with an adhesive, or the adhesive can be applied to a side of the labels facing away from the label carrier tape before the labels are detached from the label carrier tape.

As an alternative embodiment, the label tape can also consist only of labels that are joined together to form a label tape. These can be divided or separated downstream of the apparatus, for example by a separating element, such as a knife, thereby breaking up the label tape and separating it into the individual labels. The individual labels can then optionally be provided with an adhesive, if required, and transferred to containers.

The joining device can join the ends of the label tapes, for example by applying heat and/or an adhesive. This can be done in a direction that is transverse to the conveying direction of the label tapes or at least of the second label tape.

The detection device can, for example, be configured as a camera and capture one or more images of the relative arrangement between the first label end and the second label end in order to determine how they are positioned relative to one another. Alternatively or additionally, the detection device may also detect a color pattern and/or one or more cut marks, for example, and use this as a basis to determine how the first label end and the second label end are positioned relative to one another. Additionally, the detection device can, for example, use the detected color patterns or cut marks to detect whether the label ends are arranged with the right orientation. Alternatively or additionally, the detection device may, in addition to detecting the relative arrangement of the label ends, also provide that the detection device detects color patterns and/or cut marks of the first and/or second label tape in order to check whether these are present at all and/or as intended. This eliminates the need for additional sensors or other detection devices.

The detection device may be associated with a lighting device that can at least illuminate the two label ends. The illumination can be diffuse (e.g., from a direction that forms an angle with an optical axis of the camera or other detection device) or coaxial illumination by means of an optical system of the detection device (e.g., a camera, for example in the form of ring illumination). It may also be provided that the lighting device is configured to alternately illuminate the label ends with coaxial and diffuse lighting.

This apparatus can reliably compensate for a deviation in the relative arrangement (for example, compared with a desired relative arrangement) between the label ends by either appropriately controlling the joining device and/or by providing a message to an operator that can inform the operator of the deviation from the desired relative arrangement. The operator can then manually align the label ends until they match the desired arrangement. This ensures reliable transport of the label tape even after changing from a first label tape to a second label tape, which can also improve the reliability of subsequent labeling results.

It may be provided that the apparatus comprises a plurality of feed devices and that the joining device is movably arranged between the feed devices.

Each feed device can provide a label tape in any form (for example, as a roll) and convey it toward the withdrawal device or the joining device. The feed devices can, for example, be arranged in parallel with one another along an axis of rotation of the respective label rolls and may optionally have separate drive means for moving the label tapes they provide. In connection with this embodiment, controlling the joining devices can particularly advantageously include initially determining the relative alignment of a first feed device or a first label end of a first label tape to the second label end and, if this relative arrangement corresponds to a target value, for example, joining this label tape to the second label tape. If the relative arrangement does not correspond to a desired arrangement, it may be provided that every other feed device and the label tape stored therein is successively checked by the detection device with regard to the relative arrangement thereof to the second label end, and as soon as a first feed device is identified for which the relative arrangement corresponds to a desired arrangement, the label tape provided by this feed device can be joined to the second label tape. This can reduce the number and/or frequency of manual interventions when feeding label tapes. This embodiment uses as little space as possible in the direction of transport of the second label tape for producing the join between the first label end and the second label end, which can advantageously reduce the amount of material used.

In one embodiment, it is provided that the detection device is arranged to be movable together with the joining device. This can reduce the number of detection devices, especially when a plurality of feed devices are provided, which can lower the number of components used and thus the costs of the apparatus.

The control process can include setting a joining direction in which the first label tape and the second label tape are joined by the joining device.

Setting the joining direction can either involve the joining device joining the first label end and the second label end in a direction that differs from a direction that is transverse to the conveying direction of the second label tape such that this different direction forms an angle with the conveying direction that is not 90°. This ensures that the first label end and the second label end are joined at an angle which can compensate in particular for any misalignment of the first label tape and the second label tape according to a corresponding angle. Alternatively or additionally, it may also be provided that setting the joining direction includes moving the second label end relative to the first label end so that an offset or misalignment in a certain direction between the first label tape and the second label tape can be compensated for before the labels are joined. This can reliably ensure that even if there are misalignments between the label tapes during the transition from a first label tape to a second label tape, the label tapes can continue to be reliably conveyed.

It can be provided that the message comprises information relating to the necessary alignment of the first label end and/or the second label end on the basis of the relative arrangement. For example, if the relative arrangement does not correspond to a desired relative arrangement, the message can contain information about how the first label end or the second label end needs to be moved to achieve the desired arrangement. This can also improve the result with regard to further conveying the label tapes, even if manual intervention is necessary.

The apparatus can be configured to control the joining device or output the message on the basis of a comparison of the relative arrangement with a limit.

The limit can, for example, be a value that indicates up to what point a deviation between the relative arrangement and a target arrangement can still be corrected by controlling the joining device. Once this limit is exceeded, a correction may possibly only be made manually or at least by additionally manually changing the relative arrangement between the first label end and the second label end. The apparatus can therefore prevent the message from being issued if the comparison shows that a deviation in the relative arrangement can still be corrected by the joining device itself, and only issue the message when this is no longer possible. This reduces the need for manual intervention by an operator, thus improving the ease of use of the apparatus.

It can be provided that the relative arrangement comprises an offset of the first label end relative to the second label end in a direction that is transverse to a conveying direction of the second label tape and/or an angle formed by a conveying direction of the first label tape and a conveying direction of the second label tape.

The offset and the relative rotation (forming an angle between the respective conveying directions) can each lead to an adverse labeling or conveying result of the label tapes. If the relative arrangement is checked for this, an unfavorable labeling or conveying result can be avoided through appropriate correction or an appropriate message.

It may be provided that the control process includes controlling the joining device to compensate for the offset and/or the angle formed and/or that the message includes information relating to a correction of the offset and/or the angle. The offset or the angle formed can be compensated for by moving the label ends relative to one another and/or by changing the position or course of the join between the first label end and the second label end. The information relating to a correction of the offset and/or angle may, for example, include details on how the first and/or second label end needs to be moved to correct the offset or the angle formed as much as possible. It is not necessary for the operator to also be informed of the actual size of the offset via the message, as the operator is only required to correct it. The information can be based, for example, on alignment markings of the feed device and/or the apparatus in general, in order to provide the operator with the most user-friendly instructions possible for implementing the correction.

According to the invention, a method for conveying and joining label tapes by means of an apparatus for conveying and joining label tapes is further provided. The apparatus includes a feed device for a first label tape, a withdrawal device for a second label tape, a joining device for joining a first label end of the first label tape to a second label end of the second label tape, and a detection device for detecting a relative arrangement of the first label end and the second label end. The method comprises using the detected relative arrangement as a basis for controlling the joining device for joining said labels and/or outputting a message that is based on the relative arrangement detected.

This method makes it possible to change from a first label tape to a second label tape while continuing to reliably convey them and maintaining a high-quality labeling result.

It may be provided that the apparatus further comprises a plurality of feed devices and that the joining device is movably arranged between the feed devices. Each feed device can provide exactly one first label tape or a plurality of first label tapes. By providing a plurality of feed devices, and in particular a plurality of first label tapes, the flexibility and time available for compensating for a relative offset between the first label end and the second label end, for example, can be increased.

In one embodiment, it is provided that the detection device is arranged to be movable together with the joining device. This allows the number of components and thus the complexity of the apparatus to be reduced, while simultaneously achieving a good labeling and transport result for the label tapes.

It may be provided that the control process includes setting a joining direction in which the first label tape and the second label tape are joined by the joining device and/or that the message includes information regarding a necessary alignment of the first label end and/or the second label end on the basis of the relative arrangement.

This allows for either a targeted automatic correction of an offset or an angle formed between the first label tape and the second label tape, or sufficient instructions to be given to the operator to make such a correction in order to deliver a high-quality labeling result even when the label tapes are changed.

It may be provided that the apparatus controls the joining device or outputs the message on the basis of a comparison between the relative arrangement and a limit. If the limit is exceeded (or fallen below), for example, the apparatus may be provided to output the message, since, for example, an automatic correction of the relative arrangement cannot be achieved using the joining device. If the relative arrangement is below the limit, the correction can still be carried out automatically so that the necessary correction of the relative arrangement can be made without operator intervention, improving ease of use.

In one embodiment, the relative arrangement comprises an offset of the first label end relative to the second label end in a direction that is transverse to a conveying direction of the second label tape and/or an angle formed by a conveying direction of the first label tape and a conveying direction of the second label tape, wherein the control process optionally involves controlling the joining device to compensate for the offset and/or the angle formed and/or wherein the message optionally comprises information relating to a correction of the offset and/or the angle. This allows for a reliable response to deviations of the relative arrangement from a potentially specified target arrangement.

All of the embodiments described here can be combined with one another.

### BRIEF DESCRIPTION OF THE FIGURES

FIG. 1 shows an embodiment of an apparatus for conveying and joining label tapes.

FIG. 2 shows an embodiment of the offset between label tapes.

FIG. 3 shows an embodiment of an angle formed between label tapes.

FIG. 4 shows a flow diagram of a method for operating an apparatus, for example according to FIG. 1.

### DETAILED DESCRIPTION

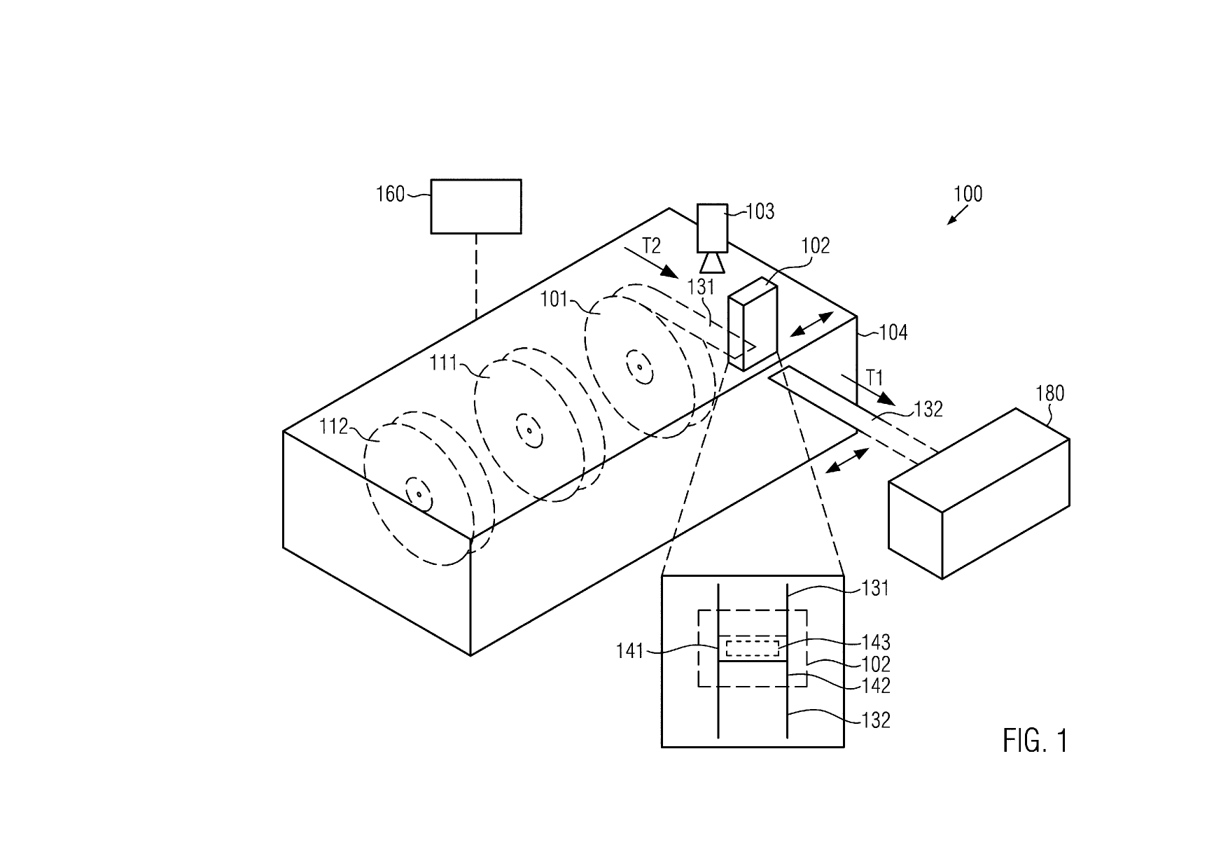

FIG. 1 shows an apparatus 100 for conveying and joining label tapes 131 and 132. In the following, the label tape 131 will be referred to as the first label tape and the label tape 132 as the second label tape, these designations being intended only for the purpose of easier identification.

The apparatus 100 can in principle be used in combination with a labeling machine 180, which applies labels to containers. The operation and configuration of such labeling machines 180 are generally known. It is desirable that the labeling machine 180 can be operated with as few interruptions as possible. To achieve this, the label stream must be as continuous as possible.

The apparatus 100 is configured to provide labels on label tapes 131 and 132 for a labeling machine 180. According to the invention, label tapes can be stored in the apparatus 100 in one or more feed devices 101, 111 and 112. For example, the first label tape 131 can be stored in the feed device 101 on a label tape roll (shown schematically here). The label tape roll can be mounted so as to rotate about an axis of rotation so that the first label tape 131 is or can be conveyed in a conveying direction T2 to a joining device 102 (to be described below). The second label tape 132, which may originate from another feed device of the apparatus 100, is conveyed in a conveying direction T1, for example in the direction of the labeling machine. To avoid an interruption during a possible necessary change of the first label tape and the second label tape (for example, at the end of the second label tape or once it has run out), the joining device 102 is provided to join a first label end of the first label tape 130 to a second label end of the second label tape 132 so as to form a continuous label tape.

As shown in the schematic enlarged view, for example, the first label end 141 of the first label tape 131 can be brought into contact with the second label end 142 of the second label tape 132 for this purpose, and adhesive 143 can be applied between them or to one of them by means of the joining device 102 to join the label ends 141 and 142 together. The joining device can additionally be configured to press the label ends 141 and 142 together in order to join them by means of the adhesive.

As an alternative to applying an adhesive, it may also be provided, for example, that the joining device at least partially melts the label ends by emitting heat so that they can stick together. The continuous label tape thus formed comprises parts of the first label tape and parts of the second label tape and can therefore be used to ensure the continuous operation of, for example, the downstream labeling machine.

According to the invention, the apparatus 100 further comprises a detection device 103, which is configured to determine a relative arrangement between the first label end and the second label end. The detection device can in principle have any configuration and may, for example, comprise one or more cameras that can capture an image of the first label end and of the second label end in a region where the first label end and the second label end are arranged relative to one another so that the label ends and their relative arrangement to one another can be determined from this image, for example using known image processing programs. The relative arrangement may in particular include an offset of the label ends relative to one of the conveying directions T1 and T2 or an angle of one of the label ends and/or label tapes formed by one of the conveying directions T1 and T2.

It may be provided that the detection device 103 is stationary. The joining device 102, on the other hand, can be arranged to be movable in a direction, for example transversely to the conveying direction T1, in order to at least form, for example, the adhesive 143 or more generally the join between the first label end and the second label end. Alternatively or additionally, the joining device can also be arranged in such a way that it is movably arranged between different feed devices 101, 111 and 112, provided these are present. The joining device 102 can thus be moved between the various feed devices 101, 111 and 112 to join a second label tape and a first label tape. By providing a plurality of feed devices 101, 111 and 112, the frequency with which, for example, an empty feed device (e.g., a feed device where the label roll has run out) has to be restocked with a new label roll to ensure smooth operation can be reduced. This can be particularly advantageous if the label rolls have to be changed manually.

In one embodiment, it can also be provided that the detection device 103 is arranged to be movable together with the joining device 102. For example, the detection device 103 can be arranged on the joining device, for example screwed thereto or to a frame thereof. In this way, the detection device can be carried along with the joining device, and it is not necessary to provide a separate detection device 103 for each feed device to determine the relative arrangement between a label tape fed by that specific feed device and the label tape 132.

Although not shown here, it may be provided that a buffer system is arranged downstream of the joining device 102 in the conveying direction T1, by means of which the second label tape 132 can be at least partially buffered. The buffer system can, for example, comprise a plurality of rotatably mounted buffer rollers arranged to move in a translational manner in at least one direction that is perpendicular to the relevant axis of rotation. By changing the distance between the buffer rollers, the distance to be traveled by the label tape can be changed. This allows the second label end 142 to be stopped or fixed without the label tape tearing, at least in the event that the label ends of the label tapes 131 and 132 need to be joined, despite the second label tape 132 continuing to be conveyed. Such buffer systems are generally known. This allows the first label tape and the second label tape to be joined by the joining device 102 even during operation. This can reduce downtime.

Additionally or alternatively, such a buffer system makes it possible to move the second label end 132 back and forth between the different feed devices, for example by means of the joining device 102, without the risk of the label tape tearing and/or the operation of the apparatus or a downstream labeling machine having to be stopped. This makes it possible to determine the relative arrangement of the first label end of the label tape of each of the feed devices 101, 111 and 112 to the second label tape 132. As will be described in connection with FIG. 3, this can be used to determine whether a first label end of a particular feed device and the second label end of the second label tape are suitably arranged relative to one another for joining the label ends.

The invention is not limited with regard to the number of feed devices 101, 111 and 112. Preferably, at least two or more, for example three, five or ten, feed devices can be provided, in each of which a label tape can be stored and fed. Alternatively or additionally, it may also be provided that a plurality of label tapes are stored in each feed device, which can be transported independently of one another in the direction of the joining device or a corresponding second label tape.

As already described, the detection device can, for example, be configured as a camera, in particular as a camera that can capture images in the visible range of the spectrum. The relative arrangement between the label tapes or the label ends can be achieved either by detecting (with suitable image processing programs) the label tapes (especially the label ends) themselves, or certain markings on the label tapes, such as certain combinations of dashes, lines or other geometric shapes. In the latter case, the detection device can also be configured as a detection device that can capture images in the non-visible range, for example in the infrared or UV range. This can be advantageous if the markings are not visible in the visible range, but are visible in the corresponding non-visible range, for example in the infrared range or UV range. Such markings can be used, for example, to reduce the space required on each of the label tapes for joining the label ends, or to minimize the portion of the label tapes which with visible markings that are not part of the labels or that are not related to the motifs of the labels.

The apparatus 100 is configured according to the invention to control the joining device for joining the label ends on the basis of the detected relative arrangement between the first and second label ends to one another and/or to output a message to an operator on the basis of the relative arrangement.

Controlling the joining device at least includes joining the first label end and the second label end, as described, for example, by applying adhesive and optionally pressing the label ends together. Depending on the relative arrangement, controlling the joining device may also include the joining device or part thereof changing the relative arrangement between the first label end and the second label end. This can be used, for example, to change or correct an offset transversely to the conveying direction or in parallel with the conveying direction, or a combination thereof.

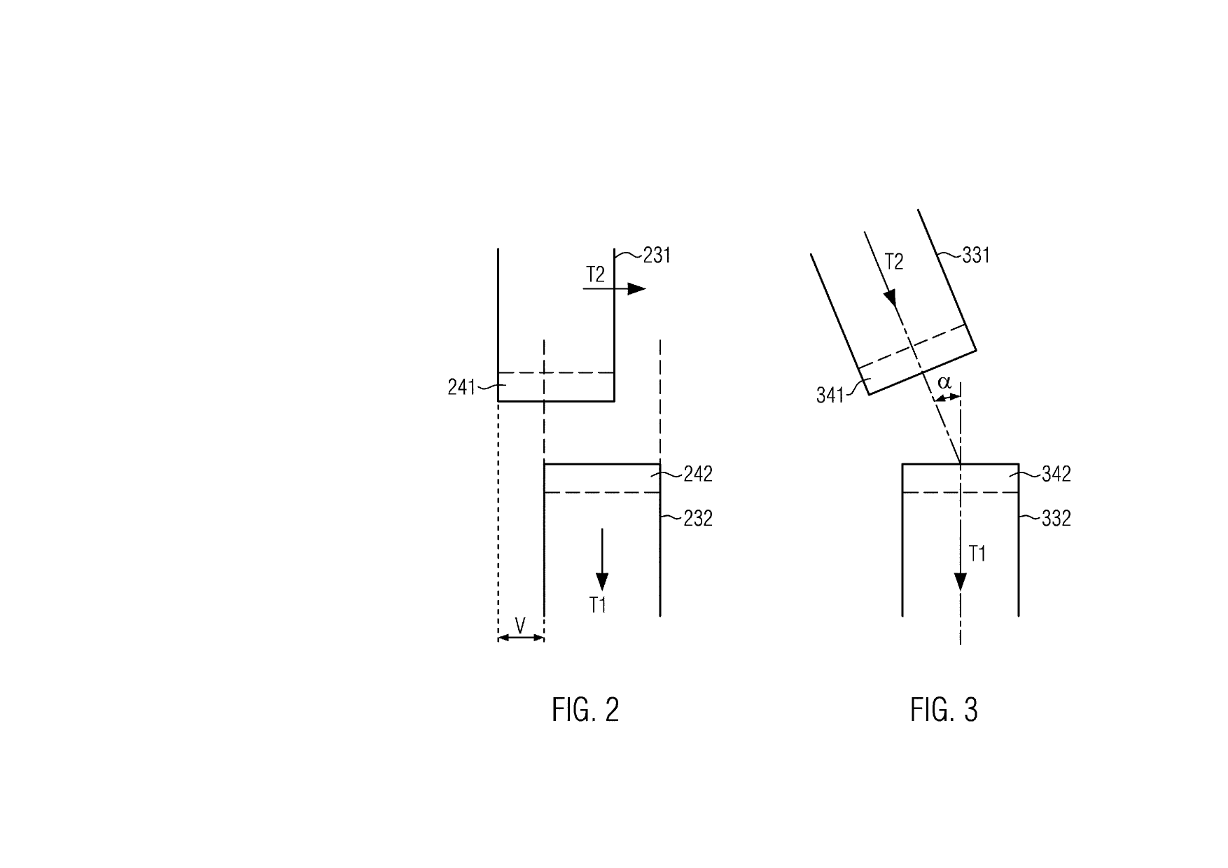

Alternatively or additionally, as described with reference to FIG. 2 and 3, it can also be an angle formed between the conveying directions T1 and T2 or, more generally, the label tapes 131 and 132. The joining device 102 can, for example, have clamps that are movable relative to one another for clamping one or both label tapes, wherein, by moving the clamps together with the clamped label tapes relative to one another, the relative arrangement thereof can be changed. This change can be carried out, for example, by transforming the relative arrangement of the label ends from an original relative arrangement into a desired or target arrangement of the label ends by moving the label ends in a translational manner to one another or rotating them relative to one another, and then applying the adhesive or, more generally, joining the label ends.

In addition to or as an alternative to controlling the joining device, a message can be displayed on a display 160, which may be assigned to a control unit of the apparatus 100, for example, and may be configured as a laptop or tablet or similar, for example. The message can alternatively or additionally also be acoustic and not purely visual, or only acoustic and not visual, or only visual and not acoustic. The message can, for example, contain information about the relative arrangement of the label ends and output this as a numerical value, such as a deviation from a target value, for example. For example, if the label ends are offset relative to one another, the message can include a numerical value indicating the direction of the offset (for example by a sign) and the size of the offset relative to a target offset or target arrangement of the label ends relative to one another.

Alternatively or additionally, the message may also include instructions for the operator on how the label ends need to be moved relative to one another in order to transfer them from the current relative arrangement to a desired or target arrangement. For example, it may also be provided for this that the joining device or part of the apparatus 100 comprises an orientation aid, such as an alignment strip extending in the direction T1 or T2, along which the label ends can be aligned relative to one another. This strip can then be used as a basis for the instructions in the message. For example, a pictographic display and/or a numerical display displaying the necessary change in position of each of the label ends may be provided in the message.

It can optionally also be provided that the apparatus 100 both controls the joining device on the basis of the relative arrangement according to the above embodiments, and also outputs a message to the operator. This may be the case, for example, if any offset or rotation of the label ends can be corrected as reliably as possible only by both a manual change in the relative arrangement of the label ends (e.g., a rough change in the relative arrangement) and an automatic change in the relative arrangement (e.g., following the manual change in the relative arrangement) in order to reliably join the label ends.

FIG. 2 shows a relative arrangement of the label tapes 231 and 232 or the label tape ends to one another, in which the label tapes or label ends have an offset V in a direction that is perpendicular to the conveying direction. This offset can occur, for example, because the second label tape 232 or the first label tape 231 is not perfectly positioned in its respective transport device and is therefore conveyed in the correct conveying direction (i.e. in a direction that is parallel to the conveying direction T1 and/or T2), but is offset in this respect. This offset can be compensated for, for example, by pulling the joining device of one or both label ends relative to one another in the direction defined by the offset V such that the offset V disappears completely or is at least reduced to an amount that is within a tolerance limit. While only an offset in a direction that is transverse to the conveying direction T1 or T2 is shown here, the offset can also be present in a direction that is parallel to the conveying direction T1 so that, for example, the label ends do not overlap or do not overlap enough to join the label tapes. Analogously to the embodiment described above, in this embodiment the joining device can then also move both label ends or only one of the label ends in a direction that is parallel to the offset in such a way that said offset is compensated for.

FIG. 3 shows another relative arrangement of the label tapes 331 and 332 or the label ends 341 and 342. In this embodiment, the conveying direction T1 forms an angle α with the conveying direction T2 that is greater than 0° and can be, for example, 0.5° or 1° or up to 5°. This therefore means that the label tape 331 is transported in a direction T2 that does not correspond to or is not parallel to the direction T1. If the label tapes 331 and 332 are now joined, the label tape 331, which is conveyed in the direction T2, would be pulled in the direction T1. This can lead to creases or incorrect unwinding of the label tape during transport.

To compensate for this, the joining device can be provided to tilt the first and/or second label tape in such a way that the angle α formed between the label tapes or their conveying directions T1 and T2 is reduced, particularly preferably to 0° or below a tolerance value.

Alternatively or in addition to the procedure described with reference to FIG. 2 and 3 for reducing the offset and/or the rotated arrangement of the first label tape relative to the second label tape, it may also be provided that, for example, the relative arrangement is changed by adjusting the joining direction between the first label tape and the second label tape or the position at which the joining device joins the first label tape and the second label tape.

For example, by changing a direction in which the first label end and the second label end are joined in the embodiment in FIG. 3, the tensile force acting on the label tape 331 from the label tape 332 conveyed in the conveying direction T1, in particular its direction, can be changed so that the further conveying direction of the first label tape can also be changed. This allows any offset or tilting to be compensated for.

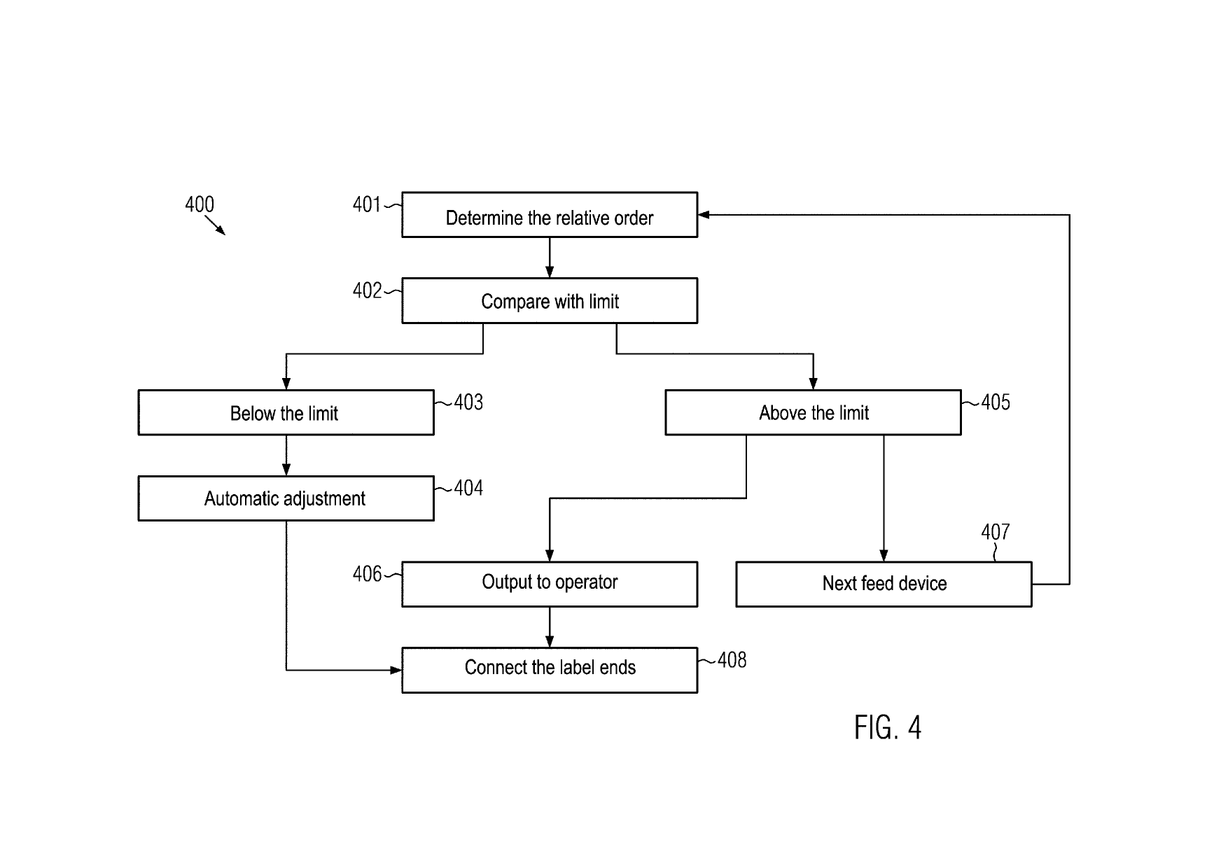

FIG. 4 shows a flow diagram of a method for conveying and joining label tapes 400 according to one embodiment.

The method begins with step 401, in which the relative arrangement between a first label end and a second label end is determined, as has already been generally described with reference to the previous embodiments. This is done using the detection device and can, for example as already described, be based on the detection of the shape and arrangement of the label ends or label tapes themselves, or, for example, based on the detection of certain markings and their relative arrangement to one another on the respective label tapes.

In step 402, the relative arrangement is compared with a limit. Since the relative arrangement can, for example, specify an offset between the first label tape and the second label tape or the corresponding label ends and/or tilting of the conveying directions relative to one another, the relative arrangement is usually a numerical value that corresponds to a difference of values. This can be compared with a limit, which can be considered the maximum permissible difference. If it is determined that the relative arrangement (and thus the difference in the position of the label ends transversely to the conveying direction, for example) is above this limit, the apparatus can act in a different manner than when the relative arrangement is below the limit.

In the embodiment described in FIG. 4, the limit indicates, in particular, up to what difference in the arrangement of the first label end and the second label end (and thus up to what numerical value of the relative arrangement) an automatic adjustment of the relative arrangement of the first label end and the second label end is still possible.

Therefore, if in step 403 it is determined that the relative arrangement or its associated value is below the limit, in step 404 the relative arrangement of the first label end and the second label end to one another can be automatically adjusted, as already described above in connection with FIG. 1 to 3.

The label ends can then be joined together in step 408 and the label tapes thus joined can continue to be transported.

However, if it is determined that the relative arrangement is above the limit (step 405), two options are provided. Firstly, in step 406, a message can be sent to the operator to change the relative arrangement between the first label end and the second label end. This can be done as in the previously described embodiments. Alternatively or additionally, it may also initially be provided that the detection device and optionally also the joining device (together with the first label tape it holds) are moved to a subsequent feed device 407 so that the relative arrangement between the second label tape and the first label tape stored in this feed device can be checked.

Steps 401 and 402 are then repeated for the further or subsequent feed device, and if it is determined that the relative arrangement is below the limit (step 403), steps 404 and 408 can be carried out. If, instead, it is again determined that the relative arrangement is above the limit (405), either the next feed unit can be used or, if all the feed units have already been checked, a message can be sent to the operator, which may include, for example, which label tape from which feed device is to be joined to the second label tape and how the relative arrangement of the first label tape and the second label tape needs to be changed. The feed device selected can preferably be the one for which the relative arrangement of the label ends has the smallest distance or the smallest difference from a target value.

The first label tape can then subsequently be joined to the second label tape in step 408 and operation can commence.

While the invention has been described with respect to certain embodiments, the description is intended to be exemplary, rather than limiting. Modifications and changes may be made within the scope of the invention, which is defined by the appended claims.

I claim:

1. An apparatus for conveying and joining label tapes, the apparatus comprising:
a feed device for a first label tape;
a withdrawal device for a second label tape;
a joining device for joining a first label end of the first label tape to a second label end of the second label tape; and
a detection device for detecting a relative arrangement between the first label end and the second label end;
wherein the apparatus is configured to use the detected relative arrangement to control the joining device for joining said labels and/or to send a message to an operator that is based on the relative arrangement.

2. The apparatus according to claim 1, wherein the apparatus further comprises a plurality of feed devices and the joining device is movably arranged between the feed devices.

3. The apparatus according to claim 1, wherein the joining device can join the first label tape and the second label tape in a direction that is transverse to a conveying direction of the second label tape.

4. The apparatus according to claim 1, wherein the detection device is arranged to be movable together with the joining device.

5. The apparatus according to claim 1, wherein the apparatus is further configured to control the joining device by setting a joining direction in which the first label tape and the second label tape are joined by said joining device.

6. The apparatus according to claim 1, wherein the message includes information on the necessary alignment of the first label end and/or the second label end on the basis of the relative arrangement.

7. The apparatus according to claim 1, wherein the apparatus is further configured to control the joining device or output the message on the basis of a comparison between the relative arrangement and a limit.

8. The apparatus according to claim 1, wherein the relative arrangement comprises an offset of the first label end relative to the second label end in a direction that is transverse to a conveying direction of the second label tape and/or an angle formed by a conveying direction of the first label tape and a conveying direction of the second label tape.

9. The apparatus according to claim 8, wherein the apparatus is further configured to control the joining device to compensate for the offset and/or the angle formed and/or wherein the message comprises information relating to a correction of the offset and/or the angle.

10. A method for conveying and joining label tapes by means of an apparatus for conveying and joining label tapes, the apparatus including a feed device for a first label tape, a withdrawal device for a second label tape, a joining device for joining a first label end of the first label tape to a second label end of the second label tape, and a detection device for detecting a relative arrangement between the first label end and the second label end, the method comprising:
using the relative arrangement detected as a basis for controlling the joining device for joining said labels and/or outputting a message that is based on the relative arrangement.

11. The method according to claim 10, wherein the apparatus further includes a plurality of feed devices and the joining device is movably arranged between the feed devices.

12. The method according to claim 10, wherein the detection device is arranged to be movable together with the joining device.

13. The method according to claim 10, wherein said controlling the joining device involves setting a joining direction in which the first label tape and the second label tape are joined by said joining device and/or
wherein the message comprises information relating to the necessary alignment of the first label end and/or the second label end on the basis of the relative arrangement.

14. The method according to claim 10, wherein said controlling the joining device and/or outputting the message is performed on the basis of a comparison between the relative arrangement and a limit.

15. The method according to claim 10, wherein the relative arrangement comprises an offset of the first label end relative to the second label end in a direction that is transverse to a conveying direction of the second label tape and/or an angle formed by a conveying direction of the first label tape and a conveying direction of the second label tape, wherein the control process optionally involves controlling the joining device to compensate for the offset and/or the angle formed and/or wherein the message optionally comprises information relating to a correction of the offset and/or the angle.
